(19) United States
(12) Patent Application Publication
(10) Pub. No.: US 2014/0185491 A1
(43) Pub. Date: Jul. 3, 2014

(54) Systems and Methods for Providing Telecommunications

(71) Applicant: Simon Ma, Sydney (AU)

(72) Inventor: Simon Ma, Sydney (AU)

(21) Appl. No.: 14/142,850

(22) Filed: Dec. 29, 2013

(30) Foreign Application Priority Data
Dec. 29, 2012 (AU) 201290568.1

(51) Int. Cl. H04L 29/06; H04M 17/00

(52) U.S. Cl. CPC H04L 65/1096; H04M 17/00
USPC 370/259

(57) ABSTRACT

A system for forwarding a call intended for a local telephone number to an overseas telephone number, the system including: an interface for receiving user input, the input including at least the local telephone number; a server for selecting a first access number from a pool of available access numbers, the access numbers each providing access to the server; and a processor for redirecting the call intended for the local telephone number to the first access number; wherein the server is further arranged to reroute the call to the overseas telephone number; and a method of use therefor.

### FIELD OF THE INVENTION

The present invention relates to systems and methods for providing telecommunications.

### BACKGROUND OF THE INVENTION

The following discussion of the background art is intended to place the invention in an appropriate context and to allow the unique characteristics and advantages of it to be more fully understood. However, any discussion of the background art throughout the specification should in no way be considered as an express or implied admission that such prior art is widely known or forms part of common general knowledge in the field.

Many travellers, especially business people and high ranking executives, are required to remain contactable at all times, even while physically out of the country. This is normally achieved using the ubiquitous mobile or cellular phone, with the roaming service enabled. The roaming service requires the home mobile network to have an agreement in place with the foreign mobile network at the destination. As, in effect, two mobile networks are cooperating to charge the user money, roaming services are infamous for being notoriously expensive. This is particularly true of data and internet related roaming services.

A partial solution to the problem of exorbitant roaming charges is to purchase a prepaid service at the destination. However, while this alleviates the problem of an expensive roaming service, it does not allow the user to remain contactable at all times.

Another partial solution is to forward a telephone call from a home mobile number to the destination prepaid number. However, forwarding a call incurs the same cost as making a standard telephone call. Therefore, since each forwarded call is charged as an international direct dial telephone call, there are no cost savings in this approach.

Accordingly, a need exists for an efficient way by which a user can remain contactable, even while overseas.

### SUMMARY OF THE INVENTION

It is an object of the present invention to overcome or ameliorate one or more of the disadvantages of the prior art, or at least to provide a -useful alternative.

One embodiment of the invention provides a method of forwarding a call intended for a local telephone number to an overseas telephone number, the method including the steps of:

selecting a first access number from a pool of available access numbers, the access numbers each providing access to a server;

redirecting the call from the local telephone number to the first access number; and rerouting the call from the server, accessed via the first access number, to the overseas telephone number.

One embodiment of the invention provides a system for forwarding a call intended for a local telephone number to an overseas telephone number, the system including:

an interface for receiving user input, the input including at least the local telephone number;

a server for selecting a first access number from a pool of available access numbers, the access numbers each providing access to the server; and

a processor for redirecting the call intended for the local telephone number to the first access number; and
wherein the server is further arranged to reroute the call to the overseas telephone number.

The server is preferably a VOIP (Voice Over Internet Protocol) server. Preferably, access to the server is defined by a predetermined period of time, and access to the server expires at the end of the predetermined period of time.

Preferably, in response to access to the server expiring at the end of the predetermined time, releasing the first access number and returning it back to the pool of available access numbers.

The local telephone number and the overseas telephone number are preferably both mobile telephone numbers, and each access number in the pool of access numbers is preferably a respective landline telephone number.

One embodiment provides a computer-readable carrier medium carrying a set of instructions that when executed by one or more processors cause the one or more processors to carry out a method as discussed herein.

One embodiment provides a computer program product for performing a method as discussed herein.

One embodiment provides a computer system configured to perform a method according as discussed herein.

One embodiment provides a method substantially as herein described with reference to any one of the embodiments of the invention illustrated in the accompanying drawings and/or examples.

One embodiment provides a computer-readable carrier medium substantially as herein described with reference to any one of the embodiments of the invention illustrated in the accompanying drawings and/or examples.

One embodiment provides a computer program product substantially as herein described with reference to any one of the embodiments of the invention illustrated in the accompanying drawings and/or examples.

One embodiment provides a computer system substantially as herein described with reference to any one of the embodiments of the invention illustrated in the accompanying drawings and/or examples.

### BRIEF DESCRIPTION OF THE DRAWINGS

Preferred embodiments of the invention will now be described, by way of example only, with reference to the accompanying drawings in which:

FIG. 1 illustrates a schematic overview of a system for forwarding a call intended for a local telephone number to an overseas telephone number, according to an embodiment of the invention;

FIG. 2 illustrates a flow chart of a method of forwarding a call intended for a local telephone number to an overseas telephone number, according to an embodiment of the invention;

FIG. 3 illustrates a flow chart of the call hand off process;

FIGS. 4a to 4d illustrate various screen shots of an interface to the system, according to an embodiment of the invention.

### DETAILED DESCRIPTION OF PREFERRED EMBODIMENTS

Described herein are various system and methods for forwarding a telephone call and/or a telephonic message (such as an SMS) from a local destination to an overseas destination, wherein at least part of the call is routed through a Voice Over Internet Protocol (VOIP) or like service. Note that throughout this specification, reference will be made to “telephone call” which is intended to have an all-encompassing meaning and refers to any form of telephonic communication, such as but not limited to telephone calls, mobile or cellular phone calls, VOIP calls, short or multimedia messaging service messages, instant messaging over the internet via PCs, smart phones or tablets, and the like.

In overview, the consumer purchases a period of access and when the purchase is verified, the user is assigned a dynamic direct internal dialing (DID) telephone number, and the user sets up a diversion by forwarding his/her telephone number to the assigned DID number. The DID number provides access to a server, which then converts the telephone call into an appropriate format and routes the telephone over the internet. At the destination, the user purchases or otherwise obtains a local telephone number and supplies the local telephone number to the server. Once this local telephone number information is received, the server automatically sets up a diversion between the server and the local telephone number. Once the purchased period of access expires, the dynamic DID is released back into a pool of DIDs and the diversions are automatically removed. The DID is then ready to be re-assigned to another user.

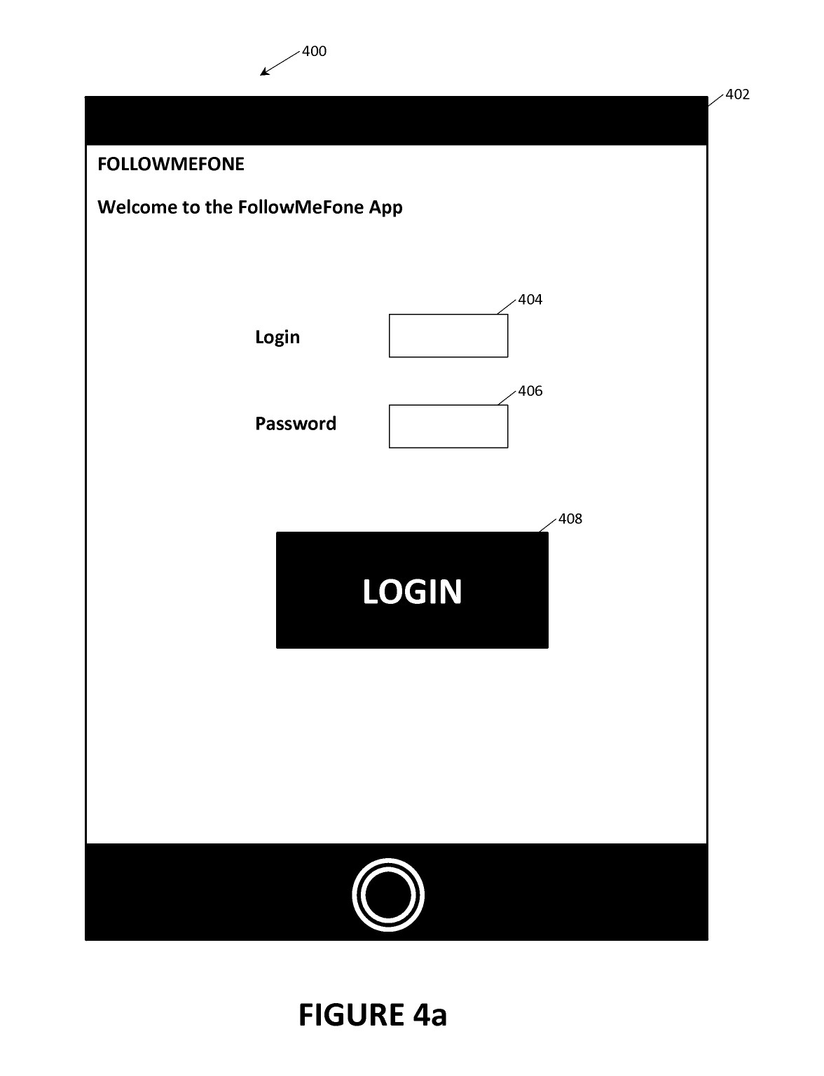

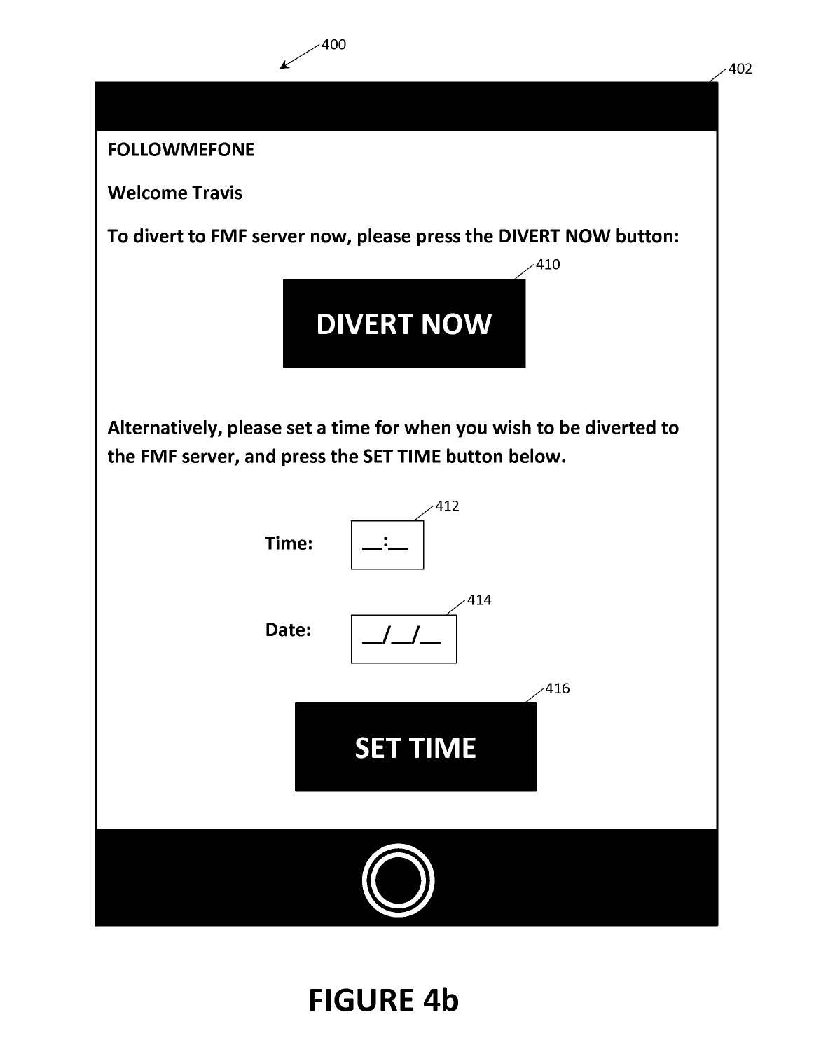

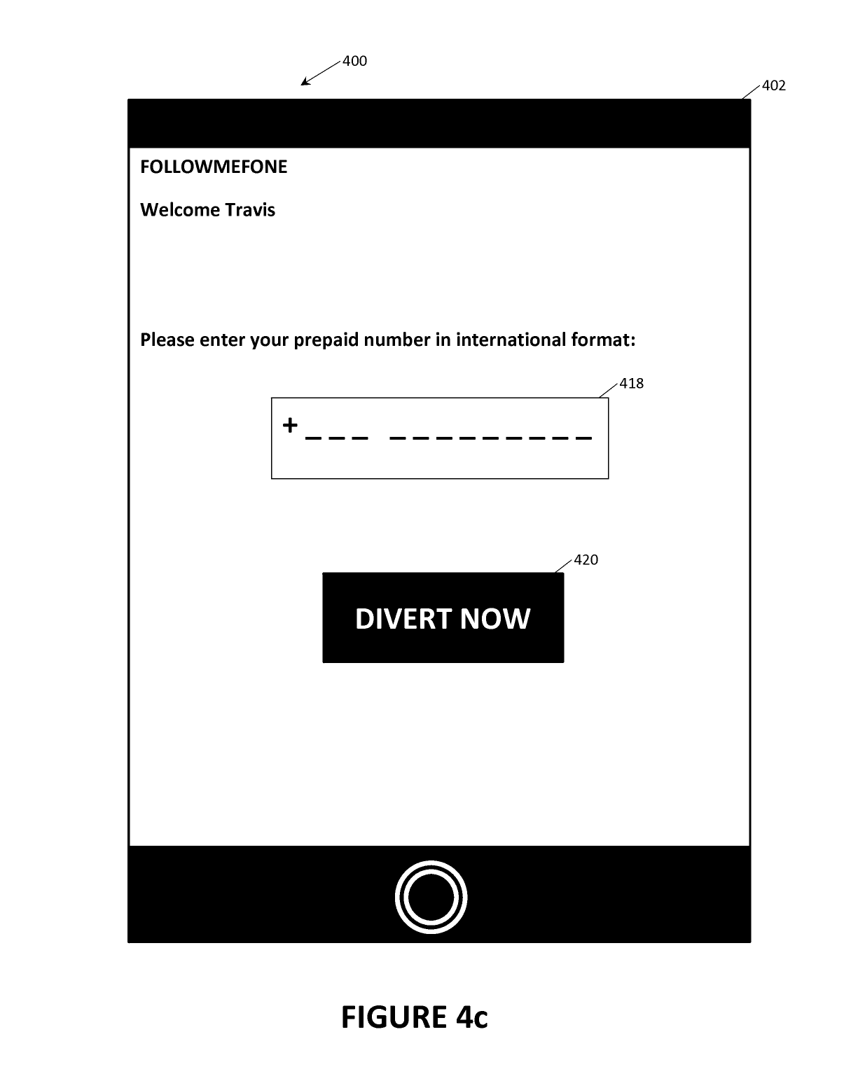

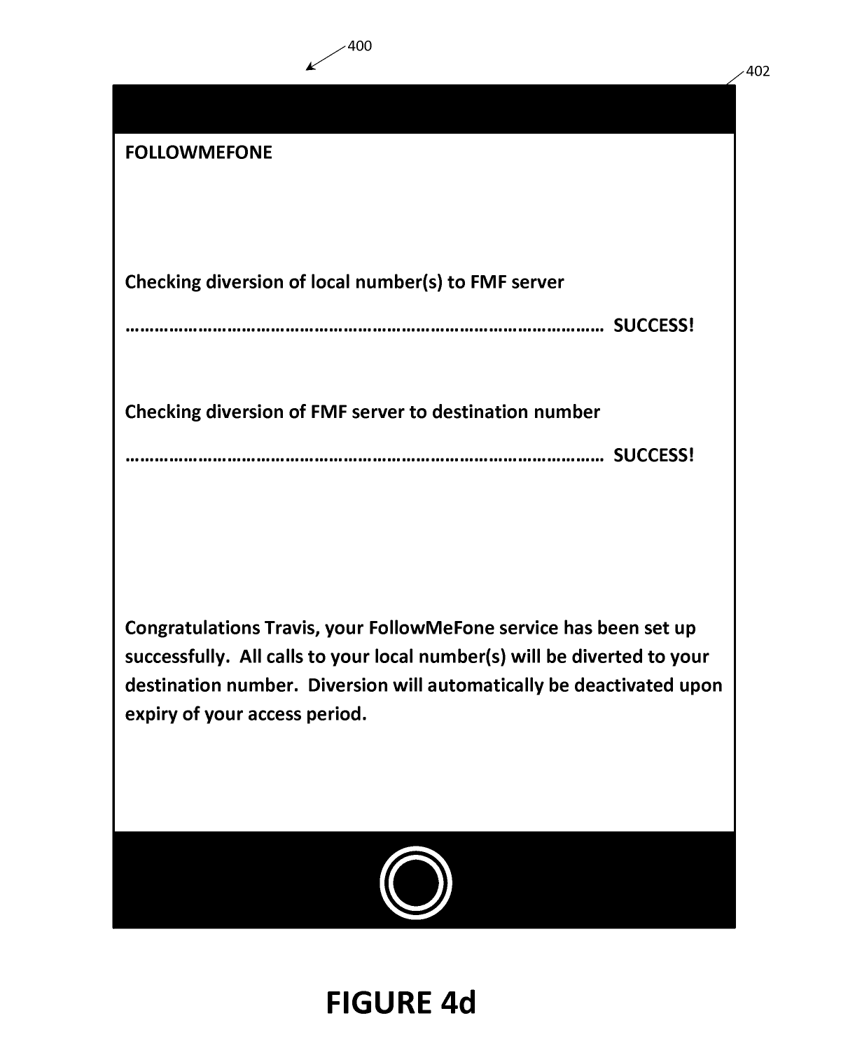

Importantly, as will be shown later with reference to FIG. 4, the process is seamless to the user, who only needs to set up the original diversion and to provide the server with the ultimate destination number.

More specifically, and according to one embodiment of the invention, there is provided a system of forwarding a call intended for a local telephone number to an overseas telephone number. When the service is activated, a first access number is selected from a pool of available access numbers, the access numbers each providing access to a server. The call is then redirected from the local telephone number to the first access number, which provides access to the server. The call is then rerouted from the server to the overseas telephone number.

In one embodiment, the server is a VOIP (Voice Over Internet Protocol) server, and access to the server is defined by a predetermined period of time. In an embodiment, the predetermined period of time is a prepaid access period that is selectively purchased by the customer. For example, under one pricing schedule, access is set at $1 per day and the customer nominates the number of days required. Under another pricing schedule, access is set in blocks of time, such as $10 per week, and the customer nominates the period of time required in weekly multiples. Under yet another pricing schedule, a minimum initial period of access is required to be purchased and additional access is added onto the initial minimum period. This is essentially a hybrid pricing schedule of those set out above. For example, the customer is required to purchase an initial minimum block of access of one week for $10, and thereafter can add additional days onto the minimum block for $1 a day. Therefore under this pricing schedule the customer pays $10 for the first 7 days of access and then $1 per day thereafter. Accordingly, for 8 days access the customer pays $11, 9 days for $12, 10 days for $13 and so forth. It will be appreciated by those skilled in the art that many pricing schedules are available and that the examples provided herein are illustrative only. At the end of the predetermined period of time, access to the server expires.

In an embodiment, the first access number is released responsive to access to the server expiring at the end of the predetermined time. When the first access number is released, it is returned back to the pool of available access numbers, ready to be reassigned to the next user that activates the service.

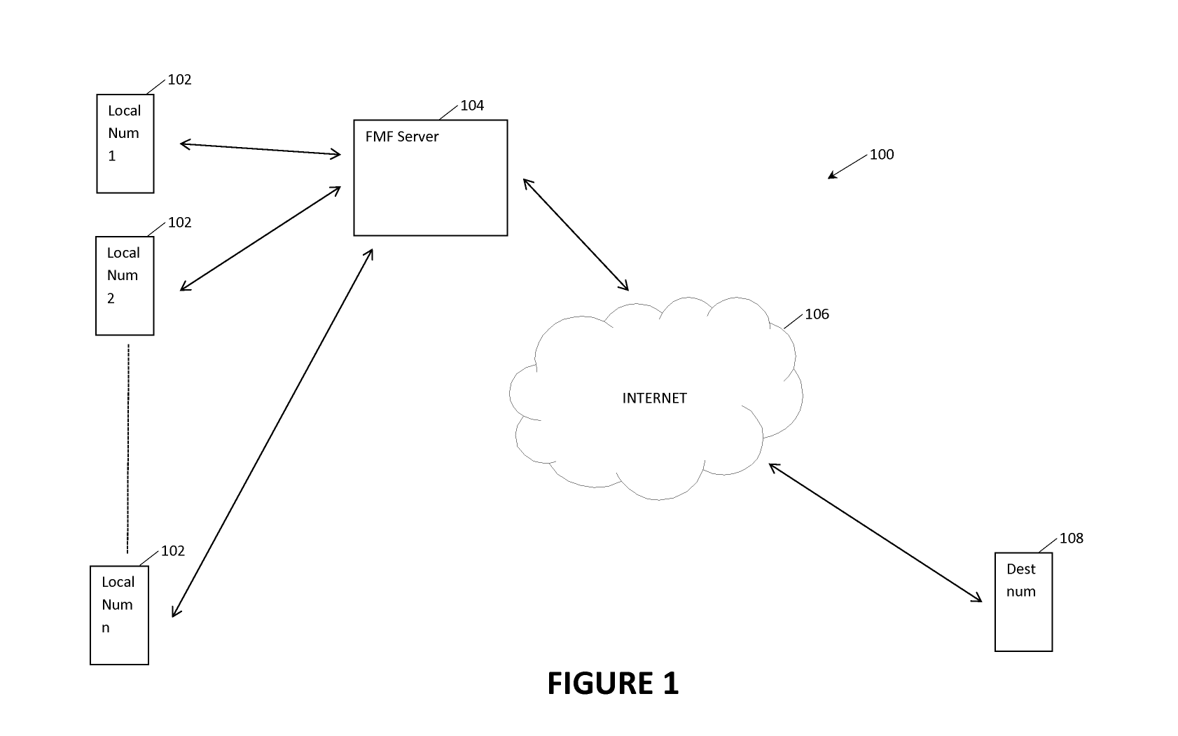

Referring now to FIG. 1, there is schematically illustrated an overview of the system 100. The embodiment of FIG. 1 shows a plurality of telephone numbers 102 (local and mobile) being forwarded to a server 104. In this embodiment, the server incorporates several functions. Firstly, the server 104 incorporates a database which is used to verify the user. The server 104 also functions to select the first access number from the pool of access numbers and assign the first access number to the user. Once the user purchases access to the server 104, the user is free to forward one or more of their local numbers 102 to the server 104. In this embodiment, the server 104 also implements a VOIP server, which digitises the analogue telephone signals that it receives from local numbers 102 and transmits the digitised signal over the internet 106 to the destination number 108. For the sake of clarity, the workings of a typical VOIP system are not discussed herein. VOIP is a known technology and assumed knowledge for those skilled in the art.

In an embodiment, the destination number 108 is a prepaid mobile telephone service which is purchased locally once the user arrives at the destination. However, it will be appreciated by those skilled in the art that the user may already have a suitable service so that purchase of a new prepaid service is unnecessary.

Once the user obtains a suitable mobile service at the destination, the user informs the server 104 of the destination number 108 so that the VOIP server can route any calls to the local numbers 102 to the correct destination.

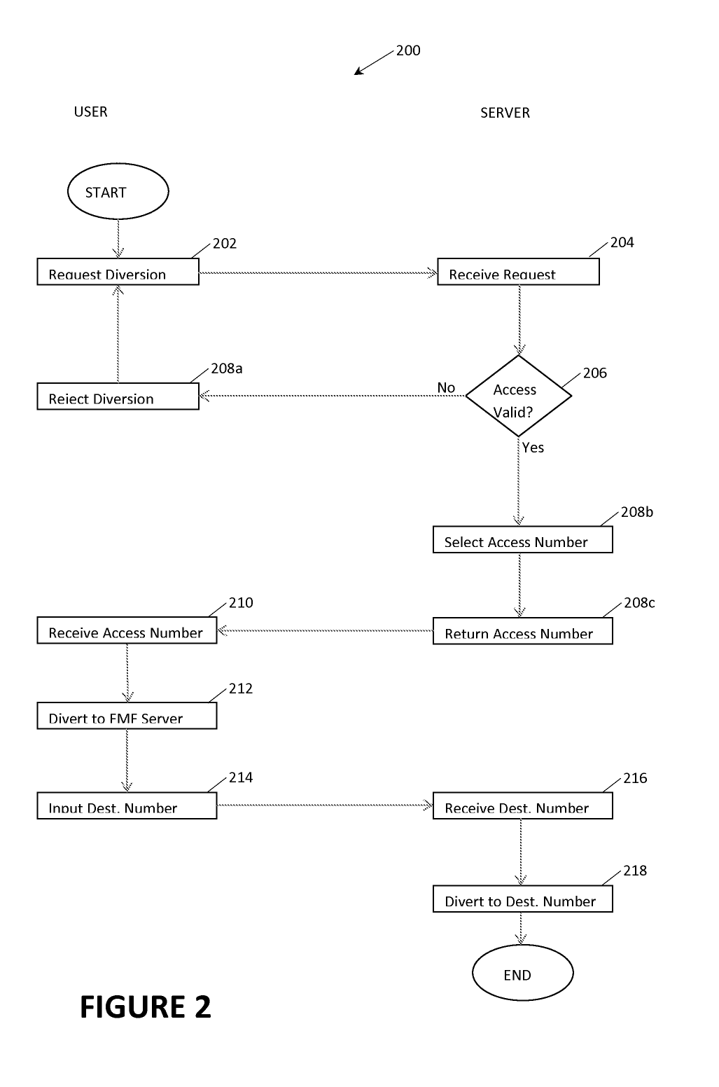

A method 200 according to an embodiment of the invention is illustrated in FIG. 2. At the start, the user requests diversion of incoming calls to their local number 102 at step 202, through an interface (such as the interface shown in FIG. 4, and discussed below). The request is received by the server 104 at step 204. In this embodiment, the request is accompanied by user login information so that the server can identify the user, and so that the server can determine whether the user has valid access to the server 104, at step 206. If the user does not have valid access to the server, the request is rejected at step 208a.

If user access is determined to be valid, an access number is selected from a pool of access numbers at step 208b, and the access number is assigned to the user at step 208c. At step 210 the user receives the assigned access number and arranges the diversion between the local number 102 and the access number.

In one embodiment, the user interface, such as the interface discussed with reference to FIG. 4, automatically configures the diversion between the local number 102 and the access number once the access number is assigned. In other embodiments it is incumbent on the user to configure the diversion the access number is received.

Once the user obtains a destination number 108, it is inputted into the interface at step 212 and sent to the server 104, which receives the destination number 108 at step 214. The server 104 then receives the destination number 108 at step 216 and configures the diversion between the server 104 and the destination number 108 at step 218.

In embodiments discussed, the process is virtually seamless and invisible to the user. The user simply provides the user login information and requests diversion, and steps 204 to 212 are handled on the backend. The next step requiring input from the user is step 214, in which the user provides the server 104 with the destination number 108. Once the server 104 receives the destination number 108, again the diversion is configured on the backend, and is virtually seamless and invisible to the user. The final step having user involvement would be to check that diversion is configured properly. In this regard, in some embodiments, the user would receive a confirmation message when the diversion is properly configured. Typically the confirmation message would be received via the interface. However those skilled in the art would recognise that there are a multitude of ways in which the confirmation message could be provided to the user, such as but not limited to SMS, MMS, telephone call, email, internet messaging, and the like.

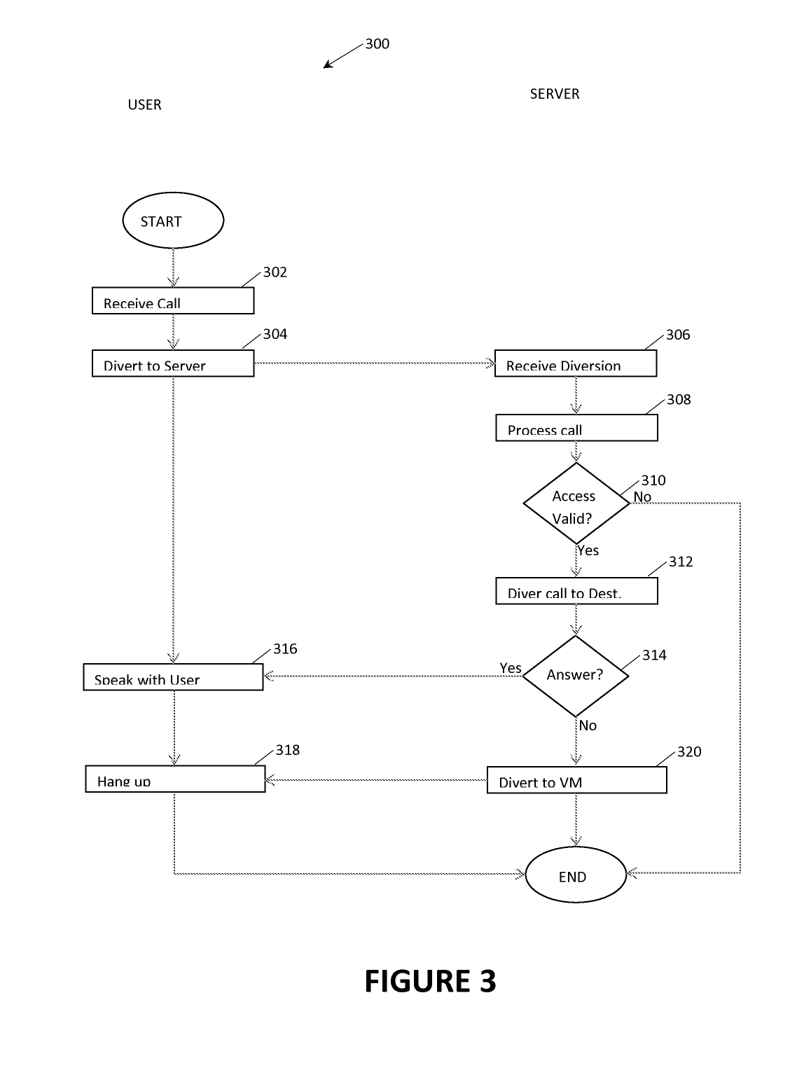

Referring to FIG. 3, there is illustrated a call hand off process 300 according to embodiments of the invention. The method starts when a call is made to the user's local number, which is received at step 302. Assuming that diversion process 200 has already been performed, the received call is then diverted to the server at step 304. The server receives the diverted call at step 306, and processes the call at step 308. At the processing step 308, the server determines the local number that the call was originally meant for, and accesses the user's account based on the local number information to determine whether the user is within a valid access period. Once it is determined that the access period is valid, at step 310, the server obtains the diversion information from the user's account and the call is diverted to that destination number at step 312. On the other hand, returning to step 310, if the access period is not determined to be valid, the call is ended directly.

At step 314, if the user answers the call, the user speaks with the caller as normal at step 316 and when the call is finished, it is hung up at step 318 and the process is ended. On the other hand, if the user is not reachable, the call is passed to step 320 which diverts the call to voicemail and the process ends once a voicemail message is recorded. An example will now be described, with particular reference to FIGS. 4a to 4d, the example is presented as an illustration of an aspect of one embodiment of the invention, and is presented as an aid to understanding the invention. It should not be interpreted as the only way to carry out the invention, or otherwise limiting in any way.

According one embodiment of the invention, the server 104 is accessed through an interface 400, the initial screen of which is shown at FIG. 4a. In this embodiment, the interface is implemented as an application, or commonly referred to as an “app”, which runs on an Apple® iPhone® 402, shown conceptually in FIGS. 4a to 4d. However, those skilled in the art will appreciate that this is not the only way in which to implement the interface. In particular, the interface may be implemented in a multitude of ways including as an app running on for example the Google® Android®platform, the Microsoft® Windows® Mobile platform, the Blackberry® BB10® platform, the Nokia® Symbian® platform, the Samsung° BADA° platform and the like. Those skilled in the art will also appreciate that the implementation of the interface is not limited to the mobile platforms, but also may be implemented as a software application running natively on a PC or a Mac, or as a web application running in the cloud and accessible through a browser (not shown).

Referring again to FIG. 4a, the interface first requires the user to enter their login and password information, at input boxes 404 and 406 respectively, and to press the LOGIN button 408 accordingly. It is assumed, in this embodiment, that the user account information has previously been set up when the user purchased the access to the server 104. Furthermore, in this embodiment, the login is the user's local number while the password is a password of the user's choosing. The password, in embodiments, may be governed by a number of rules such as a certain number of letters, an alphanumeric combination or any like conditions as will be known to those skilled in the art.

Once the user presses the LOGIN button 408, the interface 400 sends the user's login button to the server 104, via a network such as a mobile data network or via a wifi network. Assuming the user's information can be verified, and that the user has valid access to the server 104, the interface 400 proceeds to the second screen, shown at FIG. 4b. As shown in FIG. 4b, the system has identified that the user is “Travis”, and presents the user with the option of diverting “now” via the DIVERT NOW button 410. If the user presses the DIVERT NOW button 410, a “divert now” message is sent to the server 104. The server then selects an access number from the pool of available access numbers, assigns the access number to the user and returns the access number to the interface 400. The interface 400 then accesses the underlying menus of the mobile platform, enters the assigned access number and sets up the diversion between the user's mobile phone and the server 104.

In this embodiment, as again shown in FIG. 4b, the user is also offered the option of setting a time and date, by respectively entering the appropriate information into input boxes 412 and 414, and pressing the SET TIME button 416. Depressing the SET TIME button 416 performs similar actions to depressing the DIVERT NOW button 410, except that the SET TIME button 416 defers the actions until the time and date entered in input boxes 412 and 414.

This first diversion between the user's local number and the server 104 is, in one embodiment, completed before the user goes overseas. At this point the interface may be paused, and in this embodiment is reactivated when the user reaches his or her destination.

Once reactivated, the interface proceeds to the third screen, shown at FIG. 4c. This third screen allows the user to set up the second diversion, which is between the server 104 and the destination number. In embodiments, the user purchases a prepaid service at the destination, typically in the destination airport. The prepaid service will include a destination number, which is entered into input box 418. The user then depresses DIVERT NOW button 420, which again sends a “divert now” message to the server 104 via the appropriate network. When the server 104 receives the messages, it arranges for the calls to be diverted to the destination number from the server 104, thus ensuring calls to user's the local number “follows” the user to the destination number.

Once both first and second diversions have been set up, the interface 400 proceeds to the final screen, shown as FIG. 4d. At this stage of the embodiment, the system conducts a final check to confirm that the first and second diversions are in place. In embodiments, a test call may be placed to ensure that the diversion is working. In other embodiments, the checks may be conducted in other manners, and the user may be notified through other means. For example, a signal that is inaudible to humans could be passed from the local number to the destination number via the server, and if this succeeds the user is informed via an SMS message.

In this embodiment, the final screen FIG. 4c also informs the user that the diversions will automatically be deactivated upon expiry of the access period. At the end of the expiry period, the access number assigned to the user to provide access to the server 104 is unassigned, and returned to the pool of numbers. This breaks the diversion linkage between the local number and the destination number. In embodiments, it is then up to the user to remove the diversion of their local number to the previously assigned access number. In other embodiments, additional screens in the interface 400 are implemented to assist the user in removing the diversion. In yet other embodiments, all diversions are automatically adjusted following expiry of the access period.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in descriptions of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of”, or “which comprises” is an open term that means including at least the elements/features that follow, but not excluding others. Thus, the term “comprising”, when used in the claims, should not be interpreted as being limitative to the means or elements or steps listed thereafter. For example, the scope of the expression a device comprising A and B should not be limited to devices consisting only of elements A and B. Any one of the terms “including”, “which includes” or “that includes” as used herein is also an open term that also means including at least the elements/features that follow the term, but not excluding others. Thus, “including” is synonymous with and means the same as “comprising”.

Similarly, the term “coupled”, when used herein, should not be interpreted as being limitative to direct connections only. The terms “coupled” and “connected,” along with their derivatives, may be used. The scope of the expression a “device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

What is claimed is:

1. A method of forwarding a call intended for a local telephone number to an overseas telephone number, the method including the steps of:
selecting a first access number from a pool of available access numbers, the access numbers each providing access to a server;
redirecting the call from the local telephone number to the first access number; and
rerouting the call from the server, accessed via the first access number, to the overseas telephone number.

2. A system for forwarding a call intended for a local telephone number to an overseas telephone number, the system including:
an interface for receiving user input, the input including at least the local telephone number;
a server for selecting a first access number from a pool of available access numbers, the access numbers each providing access to the server; and
a processor for redirecting the call intended for the local telephone number to the first access number; and
wherein the server is further arranged to reroute the call to the overseas telephone number.

3. A method or system according to claim 1, wherein the server is a VOIP (Voice Over Internet Protocol) server.

4. A method or system according to claim 1, wherein access to the server is defined by a predetermined period of time, and access to the server expires at the end of the predetermined period of time.

5. A method or system according to claim 4, wherein in response to access to the server expiring at the end of the predetermined time, releasing the first access number and returning it back to the pool of available access numbers.
